(19) United States
(12) Patent Application Publication
(10) Pub. No.: US 2002/0135197 A1
(43) Pub. Date: Sep. 26, 2002

(54) Sun visor supplement

(76) Inventor: George A. Howard, Hackettstown, NJ (US)

Correspondence Address: STEVEN B. STEIN, ESQ., STEIN & STEIN, 164 ROUTE 10 WEST, SUCCASUNNA, NJ, 07876, US

(21) Appl. No.: 10/104,362

(22) Filed: Mar. 22, 2002

Related U.S. Application Data
(60) Provisional application No. 60/278,238, filed on Mar. 23, 2001.

(51) Int. Cl. B60J 3/00

(52) U.S. Cl. 296/97.7

(57) ABSTRACT

A supplemental sun visor that fits between the sun visors on an automobile having the side edges secured by suction cups. The supplemental sun visor may display advertising, slogans, logos or other information easily visible from outside the vehicle.

The present application claims priority to Provisional Application, Ser. No. 60/278,238, filed on Mar. 23, 2001, which is hereby incorporated by reference in its entirety.

Throughout this application, various publications are referenced. Full citations for these publications may be found listed at the end of the specification and preceding the claims. The disclosures of these publications in their entireties are hereby incorporated by reference into this application in order to more fully describe the state of the art.

### FIELD OF THE INVENTION

The present invention relates in general to supplemental sun visors and in particular to an improved supplemental sun visor that can be easily attached and detached primarily from the inner surface of an automobile windshield or rear and side windows. The present invention further provides a medium for the display of advertising, logos and messages.

### BACKGROUND OF THE INVENTION

The present invention provides a supplemental sun visor that fits between the sun visors on an automobile having the side edges secured by suction cups. The supplemental sun visor may display advertising, slogans, logos or other information easily visible from outside the vehicle.

Various types of automobile sun visors and sun visor attachments are known in the prior art. Indeed, automobiles are commonly manufactured including a pair of sun visors for use as a glare shield on the front windshield. Typically, a single visor is mounted above the front windshield on the driver's side and a second, single visor is mounted above the front windshield on the front passenger's side of the vehicle. The size and shape of the sun visors is limited by the omnipresent rear-view mirror, generally mounted in the middle or upper portion of the mid-point between the driver's side and the front passenger's side of the front windshield. As a result, a gap exists in the space between the driver's visor and the passenger's visor. When the sun is at a low angle, the driver may be exposed to blinding sun glare that impairs visibility.

Various supplemental sun visors have been suggested in the prior art, which are designed to cover the exposed area between the sun visors. However, the prior art devices use complicated mounting arrangements to mount the supplemental sun visor. Other prior art devices are subject to moving out of position because they are cannot be securely mounted. Still other prior art devices, once mounted, impede the use of the individual sun visors, typically provided by the automobile manufacturer. As a result, the supplemental sun visors of the prior art are difficult to use and are largely ineffective.

The present invention solves the problems of the prior art.

### SUMMARY OF THE INVENTION

It is therefore an object of the present invention to provide an improved supplemental sun visor for attachment to an automobile windshield in the area between the sun visors. The present invention provides a supplemental sun visor that can be used with rear view mirrors that are mounted directly on the windshield or rear view mirrors that are mounted on some other portion of the automobile interior. The provided supplemental sun visor can be mounted and removed without damaging or permanently altering the automobile.

### BRIEF DESCRIPTION OF THE DRAWINGS

FIG. 1: View of the inside surface of the provided supplemental sun visor

FIG. 2: View of a typical automobile interior showing the provided supplemental sun visor mounted in a preferred position. The automobile windshield, the rear view mirror post, the rear view mirror and standard automobile sun visors are also shown.

FIG. 3: View of the post gauge.

FIG. 4: Cut-away view of the provided supplemental sun visor, showing a slotted opening and an attachment means including a suction cup.

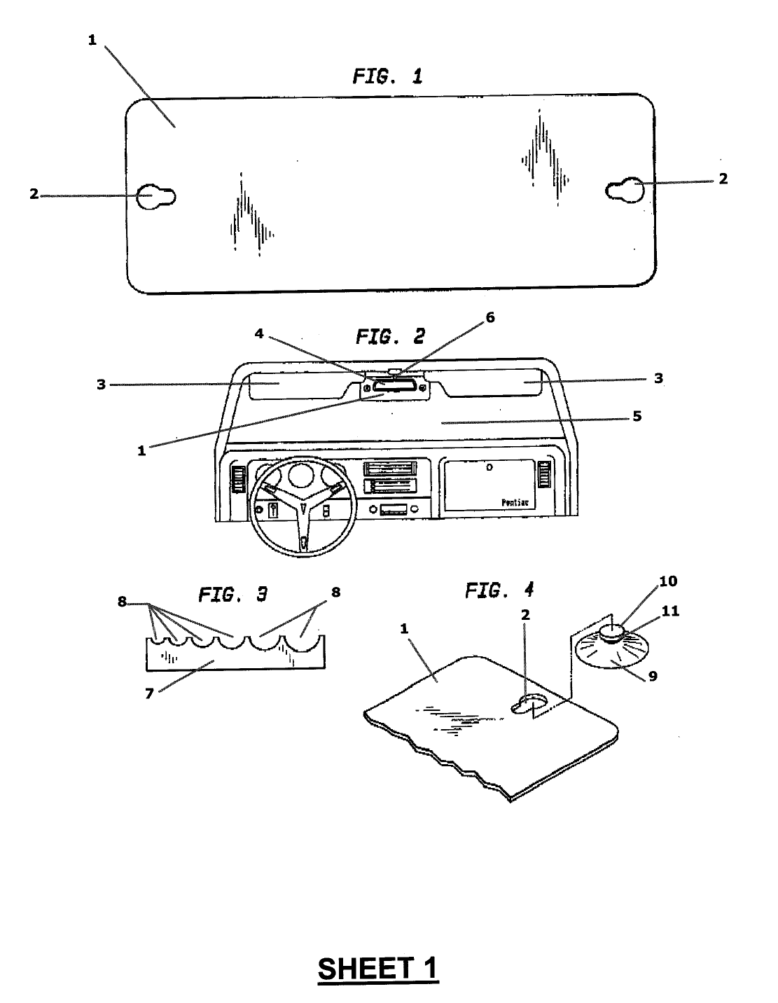

### DETAILED DESCRIPTION

Referring now to the drawings wherein like numerals refer to like and corresponding parts throughout the several views, the present invention provides a supplemental sun visor 1 for attachment to a windshield 5 comprising: an elongated panel having a top edge, a bottom edge, a left side edge, a right side edge, a front surface and a back surface; and an attachment means 9 for securing the supplemental sun visor 1 to the windshield 5 adjacent to a rear view mirror support 6. According to one embodiment of the present invention, the supplemental sun visor further comprises at least one-slotted opening 2. According to one embodiment, there is a plurality of slotted openings. A single slotted opening may be centrally positioned between the left edge and the right edge of the provided supplemental sun visor 1. According to a preferred embodiment, two slotted openings are provided, with a first slotted opening positioned near to the left edge between the top edge and the bottom edge and a second slotted opening positioned near to the right edge between the top edge and the bottom edge. According to a preferred embodiment the slotted opening is of a size suitable for stably engaging the head portion 10 of a suction cup 9. According to an embodiment of the present invention, the supplemental sun visor further comprises at least one suction cup 9. According to a preferred embodiment of this invention, the suction cup comprises a head portion 10 capable of stably engaging the provided slotted opening 2 and a cup portion, capable of attaching to a smooth surface such as a glass or plastic windshield. According to this invention, the head portion of the suction cup is capable of stably engaging in a slotted opening. According to a preferred embodiment of this invention, a plurality of suction cups is provided. According to another embodiment of the present invention, the supplemental sun visor further comprises a removable post opening, capable of circumscribing a windshield-mounted rear view mirror post. According to an embodiment of this invention, the removal portion may be perforated or otherwise pre-scored in order to facilitate removal without need for special tools. According to another embodiment of the present invention, the front surface of the provided supplemental sun visor is opaque. It is preferred that the surface be sufficiently opaque so as to sufficiently and substantially reduce any glare from the sun, which could impair the vision of a driver or passenger. According to yet another embodiment of the present invention, the front surface supplemental sun visor is partially transluscent. According to still another embodiment of the present invention, the front surface of the supplemental sun visor comprises a display of one selected from the group of (advertising, slogan, logo, artwork, and text). According to a preferred embodiment of this invention, the supplemental sun visor front surface is easily visible from outside the vehicle. According to still yet another embodiment of the present invention, the supplemental sun visor is plastic, Styrofoam, cardboard, metal, foam, rubber, wood. According to a preferred embodiment, the supplemental sun visor is plastic. According to yet still another embodiment of the present invention, the supplemental sun visor further comprises a storage compartment on the inside surface of the supplemental sun visor. According to another embodiment, the present invention provides a supplemental sun visor mounting kit comprising (a) the provided supplemental sun visor; and (b) a plurality of suction cups, each cup comprising a head portion and a cup portion. According to a preferred embodiment of this invention, the provided kit further comprises (c) a post gauge 7 comprising a card having a plurality of semi-circular openings 8 suitable for measuring the diameter of a rear view mirror 4 support post 6. According to this invention, a user can measure the approximate diameter of the existing support post, affixing the rear view mirror to the windshield by comparing the post gauge card semi-circular opening diameter with the rear view mirror support post. The user can then approximately measure the required opening for the slotted opening on the supplemental sun visor in order to accommodate the rear view mirror support post.

FIG. 2 shows the supplemental sun visor 1 mounted in a preferred position between the driver's individual sun visor and the front passenger's individual sun visor as typically provided in a standard automobile. The inside surface of the supplemental sun visor 1 is shown in part in FIG. 4 with the a suction cup 9 in a preferred position for assembly into a slotted opening 2. The suction cup 9 once stably positioned in the slotted opening facilitates the mounting of the provided supplemental sun visor 1 to the windshield 5 surface. Moreover, according to a preferred embodiment, the provided supplemental sun visor may be provided with a removable post opening, capable of circumscribing a windshield-mounted rear view mirror post 6, thereby further stabilizing the attachment of the supplemental sun visor to the windshield.

According to one embodiment, the supplemental sun visor 1 is attached to the automobile windshield 5 using at least one suction cup 9. Each suction cup 9 has a suction-breaking device 10 molded on its outer edge to aid in removing the suction cup 9 from the automobile windshield 5. The non-suction side of the suction cup has a stem 11 and head 10. The suction cup 9 engages the supplemental sun visor 1 by means of a slotted opening 2 in the supplemental sun visor 1 while adhering to the automobile windshield. The suction cup stem 11 fits into the slotted opening 2 of the supplemental sun visor 1 while the suction cup head 10 retains the supplemental sun visor. In order to secure the supplemental sun visor 1 from any side-to-side movement, a provided suction cup 9 is located toward the center of the slotted opening 2 within the supplemental sun visor 1. The slotted opening may be positioned on the supplemental sun visor from the extreme side edge of the supplemental sun visor or may be position on the supplemental sun visor from the edge and have an opening large enough to permit the suction cup head 10 entry through the supplemental sun visor. The width of the slotted opening is such as to permit free movement of the suction cup 9 yet narrow enough to engage the suction cup head 10.

FIG. 4 shows the post gauge 7. The post gauge 7 is used to determine the diameter of the rear view mirror 4 post 6 that secures the rear view mirror 4 to the windshield 5 of the automobile. The post gauge 7 is then used as a template to cut the proper diameter opening in the supplemental sun visor to enable the supplemental sun visor to circumscribe the rear view mirror post 6. Additionally, according to a preferred embodiment, the user may cut a transitional slot in the supplemental sun visor from either the top edge or the bottom edge to the hole to permit entry of the rear view mirror post to the hole in the supplemental sun visor. Thus, according to one embodiment, the transitional slot and opening may be cut into the supplemental sun visor in order to accommodate the rear view mirror post. According to a preferred embodiment, the top edge of the supplemental sun visor is aligned with windshield 5 frame and the suction cups 9 are aligned toward the slotted opening 2 and pressed firmly against the windshield.

Ince mounted to a windshield, the provided supplemental sun visor may be detached from the windshield. According to one embodiment, the suction cups may be disengaged from the windshield by pulling on the suction-breaking device 10 n a suction cup. According to another embodiment, a side edge of the supplemental sun visor is pushed toward the center of the supplemental sun visor until the head of the suction cup can become disengaged from the supplemental sun visor. The same edge of the supplemental sun visor is moved in the opposite direction through the slotted opening until the suction cup head 10 can become disengaged from the supplemental sun visor. The material and its thickness are critical in order to maintain the required flexibility of the supplemental sun visor in order to perform the aforementioned step. According to a preferred embodiment, the supplemental sun visor must be removed from the rear view mirror post, which is circumscribed by a post opening.

According to another embodiment, the supplemental sun visor may display advertising, slogans, logos or other information, easily visible from outside the vehicle.

The descriptions, examples and embodiments described herein are presented in order to more fully illustrate preferred embodiments of the invention. They should in no way be construed, however, as limiting the broad scope of the invention. While the invention is described and illustrated herein by references to various specific material, procedures and examples, it is understood that the invention is not restricted to the particular material combinations of material, and procedures selected for that purpose. Numerous variations of such details can be implied as will be appreciated by those skilled in the art.

### REFERENCES

1 U.S. Pat. No. 4,706,273 (the '273 patent), issued Nov. 14, 1985, “Cellular Telephone”;

2 U.S. Pat. No. 4,781,409 (the '409 patent), issued Oct. 26, 1987, “Automobile Sun Visor Attachment”;

3 U.S. Pat. No. 5,429,335 (the '335 patent), issued Nov. 30, 1993, “Article-Holding Strap Assembly For Automobile Sun Visor”;

4 U.S. Pat. No. 5,494,328 (the '328 patent), issued Oct. 25, 1994, “Automobile Sun Shade”;

5 U.S. Pat. No. 5,711,501 (the '501 patent), issued Nov. 7, 1996, “Suction Cup Attachment Assembly”;

6 U.S. Pat. No. 5,913,560 (the '560 patent), issued Jun. 22, 1999, “Supplemental Sun Shield Assembly For A Vehicle And Method For Providing And Deploying A Sun Visor Supplementing Sun Shield”

7 U.S. Pat. No. 5,921,607 (the '607 patent), issued Jan. 28, 1999, “Vehicle Sun Visor Extension”;

8 U.S. Pat. No. 5,979,967 (the '967 patent), issued Nov. 9, 1999, “Auxiliary Sun Visor For Motor Vehicles”; and

9 U.S. Pat. No. 6,024,399 (the '399 patent), issued Jul. 22, 1998, “Sun Visor For Vehicles”.

What is claimed is:

1. A supplemental sun visor for attachment to a windshield comprising:
a. an elongated panel having a top edge, a bottom edge, a left side edge, a right side edge, a front surface and a back surface; and
b. an attachment means for securing the supplemental sun visor to the windshield adjacent to a rear view mirror support

2. The supplemental sun visor according to claim 1, further comprising at least one slotted opening.

3. The supplemental sun visor according to claim 1, wherein the attachment further comprises at least one suction cup.

4. The supplemental sun visor according to claim 3, wherein the suction cup is capable of stably engaging in a slotted opening.

5. The supplemental sun visor according to claim 1, further comprising a removable post opening, capable of circumscribing a windshield-mounted rear view mirror post.

6. The supplemental sun visor according to claim 1, wherein the front surface is opaque.

7. The supplemental sun visor according to claim 1, wherein the front surface is partially translucent.

8. The supplemental sun visor according to claim 1, wherein the front surface comprises a display of one selected from the group of (advertising, slogan, logo, artwork, and text).

9. The supplemental sun visor according to claim 1, wherein the front surface is easily visible from outside the vehicle.

10. The supplemental sun visor according to claim 1, wherein the visor is plastic, cardboard, metal, foam, rubber, wood.

11. The supplemental sun visor according to claim 1, further comprising a storage compartment.

12. A supplemental sun visor mounting kit comprising:
a. the supplemental sun visor of claim 1; and
b. a plurality of suction cups, each cup comprising a head portion and a cup portion.

13. The kit of claim 12, further comprising (c) a post gauge comprising an elongated card having a plurality of semi-circular openings suitable for measuring the diameter of a rear view mirror support post.
